(19) United States
(12) Patent Application Publication
(10) Pub. No.: US 2004/0166274 A1
(43) Pub. Date: Aug. 26, 2004

(54) Removable truck lettering

(75) Inventors: John Mahn SR., Destin, FL (US); John Mahn JR., Cincinnati, OH (US); L. Joseph Merkle, Petersburg, KY (US); John F. Bentz, Cincinnati, OH (US)

Correspondence Address: WOOD, HERRON & EVANS, LLP, 2700 CAREW TOWER, 441 VINE STREET, CINCINNATI, OH, 45202, US

(73) Assignee: Specialty Adhesive Film Co.

(21) Appl. No.: 10/375,881

(22) Filed: Feb. 26, 2003

(51) Int. Cl. B32B 9/00

(52) U.S. Cl. 428/40.1; 428/99

(57) ABSTRACT

A pressure-sensitive adhesive-backed sign which is removable and repositionable is provided. The flexible sign includes a carrier with a pressure-sensitive adhesive applied to one side for adhesion to a substrate and indicia provided on the other side. A cover material can alternatively be applied to the other side providing the indicia. The sign can be easily removed from the substrate and repositioned without deforming the sign.

### BACKGROUND OF THE INVENTION

Vehicles often have signs applied to the surface to identify a company or product. Typical signs include vinyl film signs and magnetic signs decorated with vinyl, printed, or reflective material.

The application of signs is generally accomplished with ease. However, it is often the case that the sign must be removed. The user may wish to remove the sign completely, apply it to a different substrate, or, as is often the case, reposition the sign shortly after the initial application. Magnetic signs are easy to remove but do not adhere well enough for many applications. Once a typical sign is applied to a surface with a pressure sensitive adhesive, it is difficult to remove without damaging the substrate or destroying the sign itself. Removal of a sign often requires a razor blade, knife, heat gun or scraper, which can damage the substrate. Much of the adhesive from the sign is often left on the substrate, which also requires removal and, consequently, more damage.

Particularly with vinyl signs, removal of the sign destroys the sign. As the sign is pulled away from the substrate, it deforms or rips apart.

Therefore, there is a need for a sign that is easily removable and repositionable without damaging the substrate or the sign itself. Further, there is a need for a method for producing a removable and repositionable sign.

### SUMMARY OF THE INVENTION

The present invention comprises a flexible sign that can be applied, removed, and repositioned on a substrate, such as a vehicle. The sign includes a carrier with indicia provided on one side and a pressure-sensitive adhesive applied to the other side. The carrier is flexible, but strong enough to remain intact as it is removed from a substrate. The carrier is, for example, a polyester, a polycarbonate, or a thick vinyl material, and is clear or colored. The carrier may be a flexible magnet. The indicia is printed on the carrier, or the carrier can be cut by for example a water jet or knife to form the shape of the indicia. Further, a cover material can be bonded to the carrier. The cover material is, for example, a reflective film, a polyvinyl film, or other thermoplastic material. Indicia may be printed onto the cover material.

When the sign is initially applied to a substrate, it can be easily removed and repositioned by peeling it off the substrate and then reapplying it to the same or a different substrate. The sign will remain firmly adhered to the substrate over a wide variety of temperature ranges and conditions typically encountered by vehicles. The sign of the present invention is not subject to peeling or cracking. If the sign is removed after it has been adhered to a substrate for an extended period of time, only a minimal amount, if any, of the adhesive will remain on the substrate. This can be easily removed with a surface cleaner. Because of the strength of the carrier, the sign of the present invention will not deform when it is peeled off. Further, in many applications the sign can be re-used.

The objects and advantages of the invention will be further appreciated in light of the following detailed description and drawings in which:

### BRIEF DESCRIPTION OF THE DRAWINGS

FIG. 1 is a top perspective view of a preferred embodiment of the present invention.

FIG. 2 is a top perspective view of an alternative embodiment of the present invention.

FIG. 3 is a top perspective view of another alternative embodiment of the present invention.

FIG. 4 is a cross-sectional view taken at line 4-4 of FIG. 3.

FIG. 5 is a cross-sectional view taken at line 5-5 of FIG. 1.

### DETAILED DESCRIPTION

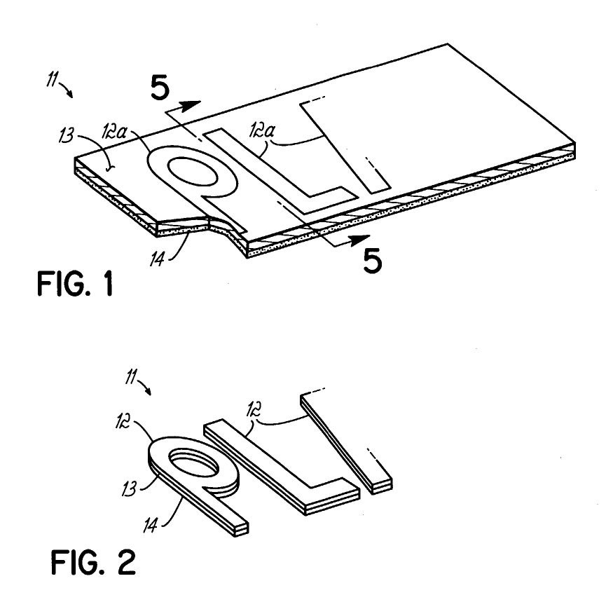

The present invention is a flexible sign 11 which can be applied, removed, and repositioned on a substrate. The present invention is particularly useful for vehicle surfaces because it withstands severe weather conditions. It is particularly described with respect to a vehicle. However, it can be used for a wide variety of substrates, such as substrates with a metal or plastic surface. Further, the shape of the sign 11 shown in FIG. 1 is exemplary. The size and shape of the sign 11 varies, depending on preference and the vehicle to which it is attached.

As shown in FIG. 1, the flexible sign 11 of the present invention includes a carrier 13 with a layer of pressure-sensitive adhesive 14 which develops a 180° peel strength of at least about 3 lb./in. applied on one side. The carrier 13 is substantially inelastic, having a yield strength sufficient to prevent stretching or ripping of the carrier 13 as the sign 11 is pulled from the substrate. However, the carrier 13 is also a flexible material.

The strength of the sign 11 is determined by measuring the yield load per unit width. The sign 11 should have a yield load per unit width of at least 25 lb./in. The preferred embodiment is also stiffer than typical vinyl signs and 2 mil polyethylene signs. The stiffness of a sign 11 is equivalent to plastic modulus times the thickness cubed. A sign 11 of the present invention should have an elastic modulus times thickness cubed value of at least about 0.02 lb-in², but not more than 50.0 lb-in² generally 0.02 to 2.0 lb-in².

The carrier 13 is preferably a polyester such as a polyethylene terephthalate, or a Mylar® brand material, a polycarbonate such as a Lexan® brand material, or a thick vinyl or plastic material, particularly a flexible magnetic material. Flexible magnets are a combination of ferrite powder combined with binder materials, such as rubber, PVC, etc.

Preferably, a polycarbonate or Mylar carrier is about 5 mil thick. Vinyl magnetic carrier material should have a thickness of at least about 10 mil. Other materials can be used and include:

| Material | Thickness |
|---|---|
| EPDM | Greater than 10 mil |
| High density polyethylene | Greater than 10 mil |
| Polyurethane | Greater than 10 mil |
| Low density polyethylene | Greater than 10 mil |

The pressure-sensitive adhesive 14 is preferably an acrylic adhesive which is non-water-soluble and preferentially adheres to the carrier 13 relative to the substrate. The pressure-sensitive adhesive 14 should have sufficient aggressiveness such that the sign 11 will remain adhered to the vehicle without falling off during normal use. The properties involved during removal of a sign are tack and peel. A preferred pressure-sensitive adhesive 14 will hold a sign 11 of the present invention at 3 lb./in. to 9 lb./in., preferably 7 lb./in.

As shown, indicia 12 is an ornamental decorative in the form of a letter, although virtually any shape indicia 12 can be formed using the present invention, including a design or logo. Further, the indicia 12 could serve a more utilitarian purpose, such as providing a reflective surface.

The carrier 13 provides the indicia 12 by either cutting the carrier 13 into the shape of the indicia 12, as shown in FIG. 2, or by printing the indicia 12a on the carrier 13 with a permanent ink, as shown in FIG. 1. The indicia 12a is printed using block, screen, lithography offset, or other similar type of printing, and is one color or multi-colored.

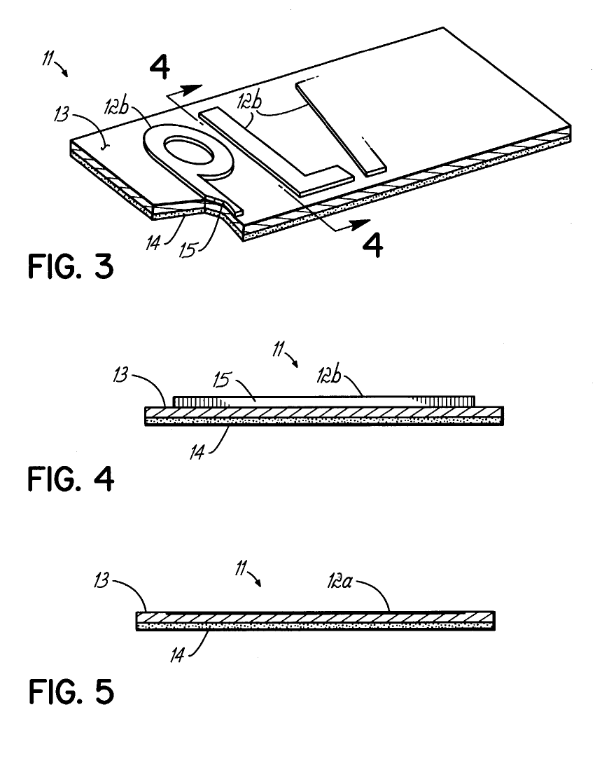

As shown in FIG. 3, an alternative embodiment of the present invention further includes a cover material 15 attached to the carrier surface, opposite the pressure-sensitive adhesive 14. Usually, the cover layer 15 is coated onto the carrier 13, but any suitable method of adhering or coating is contemplated. The cover material 15 provides the indicia 12b by cutting the cover material 15 into the shape of the indicia 12b. The cover material 15 may be a reflective film, a polyvinyl film, a thermoplastic, or any other type of material which is printable and/or can be cut with a water-jet, automatic knife or laser cutter. Alternately, the cover material can be a continuous layer with indicia printed onto the cover layer similar to FIG. 1.

One advantage of the sign of the present invention is that it can be applied to the surface of a vehicle with relative ease. If the sign is misaligned, it can be easily removed and repositioned, if necessary. Because the carrier is strong and substantially inelastic, the sign is not damaged when it is removed from the vehicle. Additionally, the substrate itself is not damaged. Another advantage is that, upon removal, the pressure-sensitive adhesive preferentially adheres to the carrier and not the substrate. If any adhesive does remain on the substrate, it is easily removed with a surface cleaner. Finally, the sign is durable in that it will accept the outdoor elements for up to six years, including car washes.

The present invention enables one to decorate a vehicle with a sign. It can be produced economically, minimizing cost. It can also be applied to, and removed from, a vehicle surface without marring the sign or the vehicle. Further, the sign remains adhered to the vehicle without cracking, peeling, or dislodging, even when subjected to, for example, the road conditions encountered by vehicles. Thus, the present invention provides a reliable, economical sign for the surface of a vehicle.

This has been a description of the present invention, along with the preferred method of practicing the invention currently known to the inventor. However, the invention itself should be defined only by the appended claims wherein we claim:

1. A flexible sign adapted to be removably adhered to a substrate comprising:
a carrier having a first and second side; and
a pressure-sensitive adhesive layer adhered to said first side, said pressure-sensitive adhesive layer having a 180° peel strength of at least about 3 lb./in.
wherein said carrier has a yield strength sufficient to prevent ripping of said carrier as said sign is pulled from said substrate, and
wherein said carrier provides indicia.

2. The sign of claim 1 wherein the sign has a yield strength of about 25 lb./in.

3. The sign of claim 1 wherein the sign has a yield strength of at least 25 lb./in..

4. The sign of claim 1 wherein the sign has an elastic modulus times thickness cubed of at least 0.02 lb-in².

5. The sign of claim 4 wherein the sign has an elastic modulus times thickness cubed of no greater than 50.00 lb-in².

6. The sign of claim 1 wherein the substrate is the surface of a vehicle.

7. The sign of claim 1 wherein the substrate is a metal surface.

8. The sign of claim 1 wherein the substrate is a plastic surface.

9. The sign of claim 1 wherein the carrier is substantially inelastic.

10. The sign of claim 1 wherein the carrier is magnetic.

11. The sign of claim 1 wherein the carrier is a polyester.

12. The sign of claim 11 wherein the carrier is a polyethylene terephthalate.

13. The sign of claim 11 wherein the carrier has a thickness of at least 5 mil.

14. The sign of claim 1 wherein the carrier is a polycarbonate.

15. The sign of claim 14 wherein the carrier has a thickness of about 10 mil.

16. The sign of claim 1 wherein the pressure-sensitive adhesive is a non-water-soluble acrylic.

17. The sign of claim 1 wherein the pressure-sensitive adhesive is preferentially adhered to the carrier relative to the substrate.

18. The sign of claim 1 wherein the carrier comprises the shape of the indicia.

19. The sign of claim 1 wherein the indicia is a permanent ink.

20. The sign of claim 1 further comprising a printable cover material attached to the second side of the carrier.

21. The sign of claim 20 wherein the cover material is a reflective film.

22. The sign of claim 20 wherein the cover material is a polyvinyl film.

23. The sign of claim 20 wherein the cover material is thermoplastic.

24. The sign of claim 20 wherein the cover material is coated onto the carrier.

25. The sign of claim 20 wherein indicia is printed on the cover material.

26. The sign of claim 20 wherein the cover material comprises the shape of the indicia.

27. A flexible sign adapted to be removably adhered to a substrate comprising:
a carrier having a first and second side;
a pressure-sensitive adhesive layer adhered to said first side, said pressure-sensitive adhesive layer having a 180° peel strength of at least about 7 lb./in.; and
a cover material adhered to said second side,
wherein said carrier has a yield strength sufficient to prevent ripping of said carrier as said sign is pulled from said substrate, and
wherein said cover material provides indicia.

28. The sign of claim 27 wherein the sign has a yield load of about 25 lb./in..

29. The sign of claim 27 wherein the sign has a yield load of at least 25 lb./in..

30. The sign of claim 27 wherein the sign has an elastic modulus times thickness cubed of at least 0.02 lb-in².

31. The sign of claim 30 wherein the sign has an elastic modulus times thickness cubed of no greater than 2.00 lb-in².

32. The sign of claim 27 wherein the substrate is the surface of a vehicle.

33. The sign of claim 27 wherein the substrate is a metal surface.

34. The sign of claim 27 wherein the substrate is a plastic surface.

35. The sign of claim 27 wherein the carrier is substantially inelastic.

36. The sign of claim 27 wherein the carrier is magnetic.

37. The sign of claim 27 wherein the carrier is a polyester.

38. The sign of claim 37 wherein the carrier is a polyethylene terephthalate.

39. The sign of claim 37 wherein the carrier has a thickness of about 5 mil to 10 mil.

40. The sign of claim 27 wherein the carrier is a polycarbonate.

41. The sign of claim 40 wherein the carrier has a thickness of about 10 mil.

42. The sign of claim 27 wherein the pressure-sensitive adhesive is a non-water-soluble acrylic.

43. The sign of claim 27 wherein a substantial amount of the pressure-sensitive adhesive is preferentially adhered to the carrier relative to the substrate.

44. The sign of claim 27 wherein the cover material is a reflective film.

45. The sign of claim 27 wherein the cover material is a polyvinyl film.

46. The sign of claim 27 wherein the cover material is thermoplastic.

47. The sign of claim 27 wherein the cover material is coated onto the carrier.

48. The sign of claim 27 wherein the indicia is printed on the cover material.

49. The sign of claim 27 wherein the indicia is a permanent ink.

50. The sign of claim 27 wherein the cover material comprises the shape of the indicia.
